(19) United States
(12) Patent Application Publication
(10) Pub. No.: US 2007/0072606 A1
(43) Pub. Date: Mar. 29, 2007

(54) Method and system for mitigating interference from analog TV in a DVB-H system

(76) Inventor: Pieter van Rooyen, San Diego, CA (US)

Correspondence Address: MCANDREWS HELD & MALLOY, LTD, 500 WEST MADISON STREET, SUITE 3400, CHICAGO, IL, 60661, US

(21) Appl. No.: 11/236,962

(22) Filed: Sep. 28, 2005

(51) Int. Cl. H04Q 7/20

(52) U.S. Cl. 455/434

(57) ABSTRACT

Certain embodiments of mitigating interference from analog TV in a DVB-H system may include receiving feedback information from at least one mobile terminal that receives digital broadcast television signals and interfering analog broadcast television signals. The feedback information may comprise channel estimates. Subsequently transmitted digital broadcast television signals may be adjusted using a plurality of weights based on the received feedback information. This may mitigate interference from the analog broadcast television signal at the mobile terminals.

### CROSS-REFERENCE TO RELATED APPLICATIONS/INCORPORATION BY REFERENCE

This application makes reference to:
U.S. patent application Ser. No. ______ (Attorney Docket No. 16847US01), filed Sep. 28, 2005; and
U.S. patent application Ser. No. ______ (Attorney Docket No. 16851US01), filed Sep. 28, 2005.

All of the above stated applications are hereby incorporated herein by reference in their entirety.

### FIELD OF THE INVENTION

Certain embodiments of the invention relate to wireless communication of data. More specifically, certain embodiments of the invention relate to a method and system for mitigating interference from analog TV in a DVB-H system.

### BACKGROUND OF THE INVENTION

Broadcasting and telecommunications have historically occupied separate fields. In the past, broadcasting was largely an “over-the-air” medium while wired media carried telecommunications. That distinction may no longer apply as both broadcasting and telecommunications may be delivered over either wired or wireless media. Present development may adapt broadcasting to mobility services. One limitation has been that broadcasting may often require high bit rate data transmission at rates higher than could be supported by existing mobile communications networks. However, with emerging developments in wireless communications technology, even this obstacle may be overcome.

Terrestrial television and radio broadcast networks have made use of high power transmitters covering broad service areas, which enable one-way distribution of content to user equipment such as televisions and radios. By contrast, wireless telecommunications networks have made use of low power transmitters, which have covered relatively small areas known as “cells.” Unlike broadcast networks, wireless networks may be adapted to provide two-way interactive services between users of user equipment such as telephones and computer equipment.

Standards for digital television terrestrial broadcasting (DTTB) have evolved around the world with different systems being adopted in different regions. The three leading DTTB systems are, the advanced standards technical committee (ATSC) system, the digital video broadcast terrestrial (DVB-T) system, and the integrated service digital broadcasting terrestrial (ISDB-T) system. The ATSC system has largely been adopted in North America, South America, Taiwan, and South Korea. This system adapts trellis coding and 8-level vestigial sideband (8-VSB) modulation. The DVB-T system has largely been adopted in Europe, the Middle East, Australia, as well as parts of Africa and parts of Asia. The DVB-T system adapts coded orthogonal frequency division multiplexing (COFDM). The ISDB-T system has been adopted in Japan and adapts bandwidth segmented transmission orthogonal frequency division multiplexing (BST-OFDM). The various DTTB systems may differ in important aspects; some systems employ a 6 MHz channel separation, while others may employ 7 MHz or 8 MHz channel separations. Planning for the allocation of frequency spectrum may also vary among countries with some countries integrating frequency allocation for DTTB services into the existing allocation plan for legacy analog broadcasting systems. In such instances, broadcast towers for DTTB may be co-located with broadcast towers for analog broadcasting services with both services being allocated similar geographic broadcast coverage areas. In other countries, frequency allocation planning may involve the deployment of single frequency networks (SFNs), in which a plurality of towers, possibly with overlapping geographic broadcast coverage areas (also known as “gap fillers”), may simultaneously broadcast identical digital signals. SFNs may provide very efficient use of broadcast spectrum as a single frequency may be used to broadcast over a large coverage area in contrast to some of the conventional systems, which may be used for analog broadcasting, in which gap fillers transmit at different frequencies to avoid interference.

Even among countries adopting a common DTTB system, variations may exist in parameters adapted in a specific national implementation. For example, DVB-T not only supports a plurality of modulation schemes, comprising quadrature phase shift keying (QPSK), 16-QAM, and 64 level QAM (64-QAM), but DVB-T offers a plurality of choices for the number of modulation carriers to be used in the COFDM scheme. The “2K” mode permits 1,705 carrier frequencies that may carry symbols, each with a useful duration of 224 μs for an 8 MHz channel. In the “8K” mode there are 6,817 carrier frequencies, each with a useful symbol duration of 896 μs for an 8 MHz channel. In SFN implementations, the 2K mode may provide comparatively higher data rates but smaller geographical coverage areas than may be the case with the 8K mode. Different countries adopting the same system may also employ different channel separation schemes.

While 3G systems are evolving to provide integrated voice, multimedia, and data services to mobile user equipment, there may be compelling reasons for adapting DTTB systems for this purpose. One of the more notable reasons may be the high data rates that may be supported in DTTB systems. For example, DVB-T may support data rates of 15 Mbits/s in an 8 MHz channel in a wide area SFN. There are also significant challenges in deploying broadcast services to mobile user equipment. Many handheld portable devices, for example, may require that services consume minimum power to extend battery life to a level that may be acceptable to users. Another consideration is the Doppler effect in moving user equipment, which may cause inter-symbol interference in received signals. Among the three major DTTB systems, ISDB-T was originally designed to support broadcast services to mobile user equipment. While DVB-T may not have been originally designed to support mobility broadcast services, a number of adaptations have been made to provide support for mobile broadcast capability. The adaptation of DVB-T to mobile broadcasting is commonly known as DVB handheld (DVB-H).

To meet requirements for mobile broadcasting the DVB-H specification may support time slicing to reduce power consumption at the user equipment, addition of a 4K mode to enable network operators to make tradeoffs between the advantages of the 2K mode and those of the 8K mode, and an additional level of forward error correction on multiprotocol encapsulated data—forward error correction (MPE-FEC) to make DVB-H transmissions more robust to the challenges presented by mobile reception of signals and to potential limitations in antenna designs for handheld user equipment. DVB-H may also use the DVB-T modulation schemes, like QPSK and 16-quadrature amplitude modulation (16-QAM), which may be most resilient to transmission errors. MPEG audio and video services may be more resilient to error than data, thus additional forward error correction may not be required to meet DTTB service objectives.

In general, a high signal-to-noise ratio of the received DVB signals may reduce an error rate of received DVB signals. However, transmitted analog TV signals may be received as noise with respect to the DVB signals and interfere with reception of the desired DVB signals. Additionally, the mobility of the handheld device may change channel characteristics with respect to the transmitted DVB signals. In this regard, as the handheld device moves with respect to the transmitting antennas, the signal strengths of both the received analog TV signals and the received DVB signals may vary. This variation may be due to factors such as, for example, multipath fading resulting from reflections and/or “dead zones” that typically causes the signal strength of desired DVB-H signal may suddenly decrease. Whenever this occurs, interference from the analog TV signals may severely degrade the DVB-H signal.

Further limitations and disadvantages of conventional and traditional approaches will become apparent to one of skill in the art, through comparison of such systems with some aspects of the present invention as set forth in the remainder of the present application with reference to the drawings. BRIEF SUMMARY OF THE INVENTION

A system and/or method is provided for mitigating interference from analog TV in a DVB-H system, substantially as shown in and/or described in connection with at least one of the figures, as set forth more completely in the claims.

These and other advantages, aspects and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1a is a block diagram of an exemplary digital television system that illustrates mobile terminals receiving digital video broadcast signals and analog TV broadcast signals, in accordance with an embodiment of the invention.

FIG. 1b is a block diagram of an exemplary transmitter and receiver system with channel estimation feedback, in accordance with an embodiment of the invention.

FIG. 1c is a block diagram of the exemplary transmitter block shown in FIG. 1b, in accordance with an embodiment of the invention.

FIG. 1d is a block diagram of the exemplary receiver block shown in FIG. 1b, in accordance with an embodiment of the invention.

FIG. 2a is a block diagram of the exemplary transmitter baseband processor shown in FIG. 1c, in accordance with an embodiment of the invention.

FIG. 2b is a block diagram of the exemplary space-time mapper block shown in FIG. 2a, in accordance with an embodiment of the invention.

FIG. 2c is a block diagram of the exemplary receiver baseband processor shown in FIG. 1d, in accordance with an embodiment of the invention.

FIG. 3 is a flow diagram illustrating an exemplary routine for reducing noise in received signals, in accordance with an embodiment of the invention.

### DETAILED DESCRIPTION OF THE INVENTION

Certain embodiments of the invention may be found in a method and system for mitigating interference from analog TV in a DVB-H system. Aspects of the method may comprise receiving feedback information from at least one mobile terminal that receives digital broadcast television signals and interfering analog broadcast television signals. The feedback information may comprise channel estimates. Subsequently transmitted digital broadcast television signals may be adjusting using a plurality of weights that are generated based on the received feedback information. The adjustment of the subsequently transmitted signals by the weights may be done in such a manner as to mitigate interference resulting from the analog broadcast television signal at the mobile terminals.

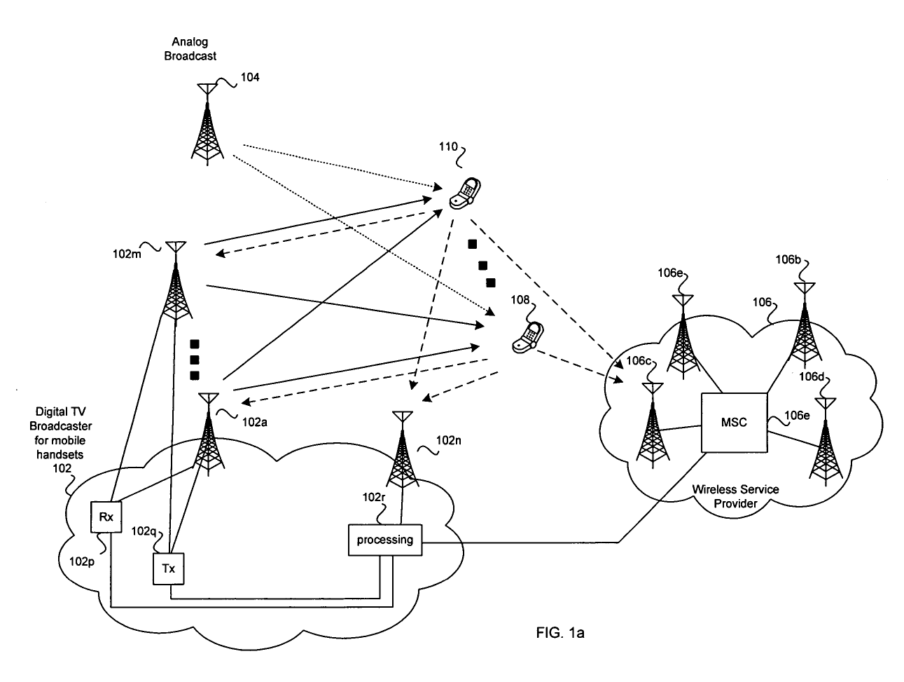

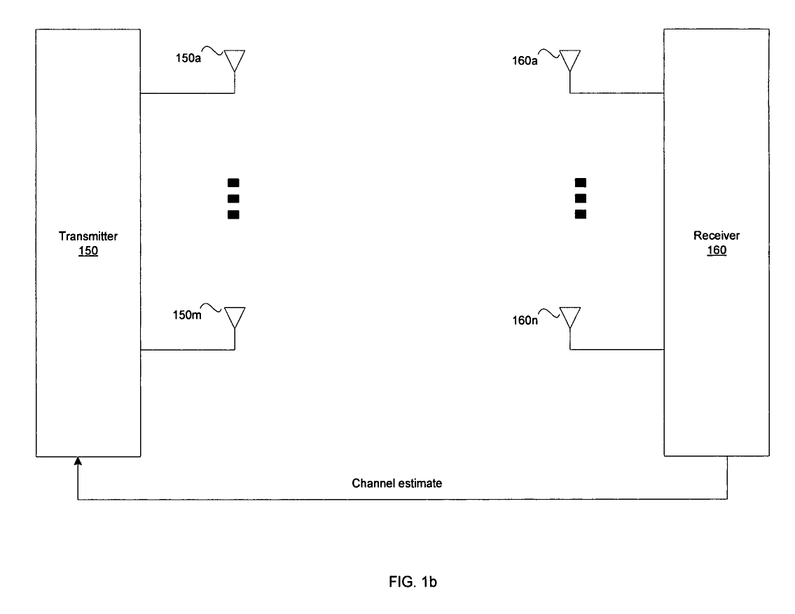

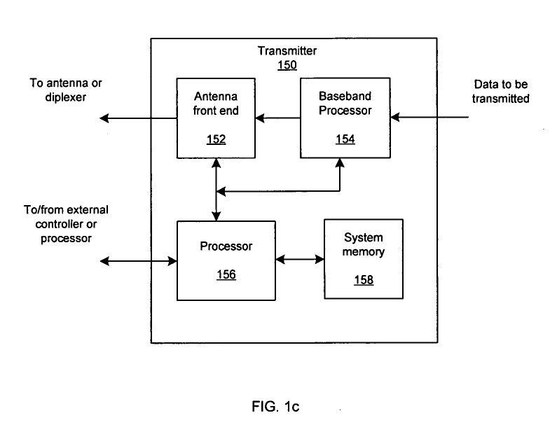

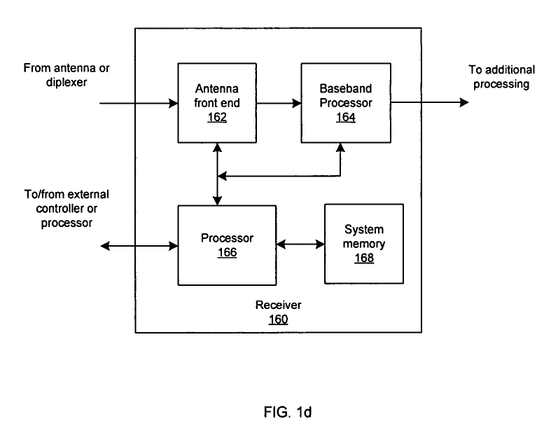

FIG. 1a is a block diagram of an exemplary digital television system that illustrates mobile terminals receiving digital video broadcast signals and analog TV broadcast signals, in accordance with an embodiment of the invention. Referring to FIG. 1a, there is shown a digital television broadcast network 102, an analog TV broadcast antenna 104, a wireless communication network 106, and mobile terminals (MTs) 108 . . . 110.

The digital television broadcast network 102 may comprise antennas 102a . . . 102m, and 102n, a receive module 102p, a transmit module 102q, and a processing module 102r. The antennas 102a . . . 102m may transmit digital television signals, and may receive feedback and/or status information from the mobile terminals 108 . . . 110. The feedback and/or status information may be, for example, specific channel estimates for each of the mobile terminals 108 . . . 110. The antenna 102n may be a dedicated receive antenna for feedback and/or status information.

The receive module 102p may comprise suitable circuitry, logic, and/or code that may be adapted to handle received signals from the plurality of antennas 102a . . . 102m and communicate the signals to the processing module 102r. The transmit module 102q may comprise suitable circuitry, logic, and/or code that may be adapted to communicate, signals to be transmitted from the processing module 102r to the plurality of antennas 102a . . . 102m. The processing module 102r may comprise suitable circuitry, logic, and/or code that may be adapted to process video data in order to be able to transmit the video data via the plurality of antennas 102a . . . 102m.

The wireless communication network 106 may comprise a mobile switching center 106a, and a plurality of antennas 106b, 106c, 106d, and 106e. Mobile terminals, for example, the mobile terminals 108 . . . 100, may communicate to other entities, such as, for example, other mobile terminals or landline telephones, via the wireless communication network 106. For example, the mobile terminals 108 . . . 110 may, in addition to voice and data communication, send feedback and/or status information for the received digital television signals to the digital television broadcast network 102 via the wireless communication network 106.

The mobile terminals (MTs) 108 . . . 110 may comprise suitable logic, circuitry and/or code that may be adapted to handle the processing of uplink and downlink channels for various cellular access technologies and broadcast VHF/UHF technologies. For example, the mobile terminals 108 . . . 110 may be adapted to receive and process digital television broadcast signals in the VHF/UHF bands or in the 802.16 frequency spectrum, as well as transmit in the VHF/UHF banks or in the 802.16 frequency spectrum. The mobile terminals 108 . . . 110 may also be adapted to utilize one or more cellular access technologies such as GSM, GPRS, EDGE, CDMA, WCDMA, CDMA2000, HSDPA and MBMS (B-UMTS).

In operation, the mobile terminal (MT) 108 may be within an operating range of the VHF/UHF digital broadcasting antennas 102a . . . 102m and within an operating range of the VHF/UHF analog broadcasting antenna 104. Although the mobile terminal may attempt to tune in to the digital signal broadcast by the antenna 102a . . . 102m, it may also receive the analog signals broadcast by the analog TV broadcast antenna 104. The signals from the analog TV broadcast antenna 104 may be within the same frequency range as the signals broadcast by the antennas 102a . . . 102m. Accordingly, the signals broadcast by the analog TV broadcast antenna 104 may appear to be noise with respect to the desired digital TV signal broadcast by the antennas 102a . . . 102m.

To mitigate the noise at, for example, the mobile terminal 108, the mobile terminal 108 may generate a channel estimate for the desired digital television signals from the antennas 102a . . . 102m. The channel estimate may be fed back to the digital television broadcast network 102. A plurality of different feedback path may be utilized. For example, an embodiment of the invention may utilize the same antennas 102a . . . 102m that transmit the digital television signals to receive the channel estimates. Alternatively, a dedicated receive antenna 102n may be adapted to receive uplink signals from the mobile terminals 108 . . . 110 comprising channel estimates. In another embodiment of the invention, the mobile terminals 108 . . . 110 may communicate their channel estimates to the digital television broadcast network 102 via an uplink channel in the wireless communication network 106. In accordance with another embodiment of the invention, an out-of-band channel may be utilized as an uplink feedback path to transfer feedback information comprising channel estimates from one or more of the mobile terminals 108 . . . 110 to the digital television broadcast network 102.

The feedback path that utilizes the antennas 102a . . . 102m and/or the antenna 102n may use one of a plurality of communication modes for communicating feedback information such as channel estimates to the digital television broadcast network 102. For example, the mobiles 108 . . . 110 may transmit the feedback information using the same frequency band used to transmit the downlink digital television signals in a time domain multiplex scheme. The mobiles 108 . . . 110 may also transmit the feedback information using a different frequency band than used to transmit the digital television signals. This may be a frequency division multiplex scheme. The particular method of feedback may be design dependent. Accordingly, the mobile terminals 108 . . . 110 may be able to transmit the feedback information in the particular frequency and multiplexing scheme chosen for feedback.

The processing module 102r may process the channel estimates from a plurality of receivers, for example, the mobile terminals 108 . . . 110. The processing of the channel estimates may result in weighting the plurality of signals transmitted by the antennas 102a . . .102m such that the signals received by the mobile terminals 108 . . . 100 may be optimized for the number of transmit antennas 102a . . . 102m and the number of channel estimates from the mobile terminals 108 . . . 110. Accordingly, transmission of the weighted signals may result in beam forming. The weighted signals that are transmitted and are received by the mobile terminals may have an increased signal-to-noise ratio when compared to transmitted signals from the same antennas that are not beam formed.

The processing module 102r may need to identify the mobile terminal from which the channel estimates are received. In one embodiment of the invention, a unique electronic serial numbers (ESN) of each of the mobile terminals 108 . . . 110 may be utilized as an identifier. Other identification unique to a mobile terminal may be used. For example, the directory number (DN) assigned to each mobile terminal may be used as an identifier. In this manner, any feedback information from a mobile may be accompanied by the mobile terminal's unique identification.

The mobile terminals 108 . . . 110 may send the feedback information periodically or aperiodically. In the latter case, for example, a mobile terminal may be adapted to send the feedback information whenever there is an appreciable change in the channel estimates. In another embodiment of the invention, the feedback information may be requested by the digital television broadcast network 102. The digital television broadcast network 102 may broadcast a general request for feedback information, or the digital television broadcast network 102 may request the feedback information from a specific mobile terminal 108 . . . 110. In instances where the digital television broadcast network 102 requests feedback information from a specific mobile terminal 108 . . . 110, then it may be necessary for the mobile terminal to identify itself to the digital television broadcast network 102 via one of the feedback paths. This may be done when a mobile terminal user selects the mobile terminal to tune in to the digital television signals or when a mobile terminal first detects the digital television signals.

The weighting of the plurality of signals may be accomplished with a precoding algorithm, for example, the Tomlinson-Harashima precoding algorithm. The Tomlinson-Harashima precoding algorithm is described in “Tomlinson-Harashima Precoding in Space-Time Transmission for Low-Rate Backward Channel,” by Robert F. H. Fischer, Christoph Windpassinger, Alexander Lampe, and Johannes B. Huber, Broadband Communications, 2002, Access, Transmission, Networking, 2002 International Zurich Seminar on 19-21 Feb. 2002, pp 7-1 to 7-6.

The digital television broadcast network 102 may be adapted to utilize VHF/UHF or at least a portion of 802.16 frequency spectrum to broadcast information to the mobile terminals 108 . . . 110. If the digital television broadcast network 102 is a DVB-H network, the DVB-H network may use ATSC, ISDB or other VHF/UHF standard. If the 802.16 frequency spectrum is used to broadcast to the mobile terminals 108 . . . 110, the 802.16 standard may be used.

FIG. 1b is a block diagram of an exemplary transmitter and receiver system with channel estimation feedback, in accordance with an embodiment of the invention. Referring to FIG. 1b, there is shown a transmitter block 150, which may be, for example, the transmit portion of the digital television broadcast network 102, and the receiver block 160, which may be, for example, the mobile terminals 108 . . . 110. There is also shown corresponding antennas 150a . . . 150m for the transmitter block 150, and the antennas 160a . . . 160n for the receiver block 160. The transmitter block 150 may also be a transmit portion of the mobile terminals 108 . . . 110.

In operation, the transmitter block 150 may transmit signals via a plurality of antennas 150a . . . 150m. The signals may be received by the receiver block 160 via at least one antenna. The receiver block 160 may demodulate the received signals from the antennas, and may generate a channel estimates for each channel. Although a plurality of antennas 160a . . . 160n may be shown for the receiver block 160, a mobile terminal may use only one antenna to receive signals. The channel estimates may be generated by using, for example, a known sequence of symbols that may be transmitted. The known sequence may be, for example, training symbols used by orthogonal frequency division multiplexing (OFDM). The channel estimates may be fed back to the transmitter block 150. The transmitter block 150 may then use the channel estimates to generate weights for signals transmitted from the antennas 150a . . . 150m. In this exemplary case illustrated with respect to FIG. 1b, the weighted signals from the antennas 150a . . . 150m may be received by at least one of the antennas 160a . . . 160n of the receiver block 160 so as to improve the signal-to-noise ratio of the received signals.

FIG. 1c is a block diagram of an exemplary transmitter block shown in FIG. 1b, in accordance with an embodiment of the invention. Referring to FIG. 1c, there is shown an antenna front end 152, a baseband processor 154, a processor 156, and a system memory 158. The antenna front end 152 may comprise suitable logic, circuitry, and/or code that may be adapted to transmit an RF signal. The antenna front end 152 may convert a digital signal from the baseband processor 154 to an analog signal, and modulate it for transmission. Moreover, the antenna front end 152 may comprise other functions, for example, filtering the analog signal, amplifying the analog signal, and/or upconverting the analog signal to an RF signal.

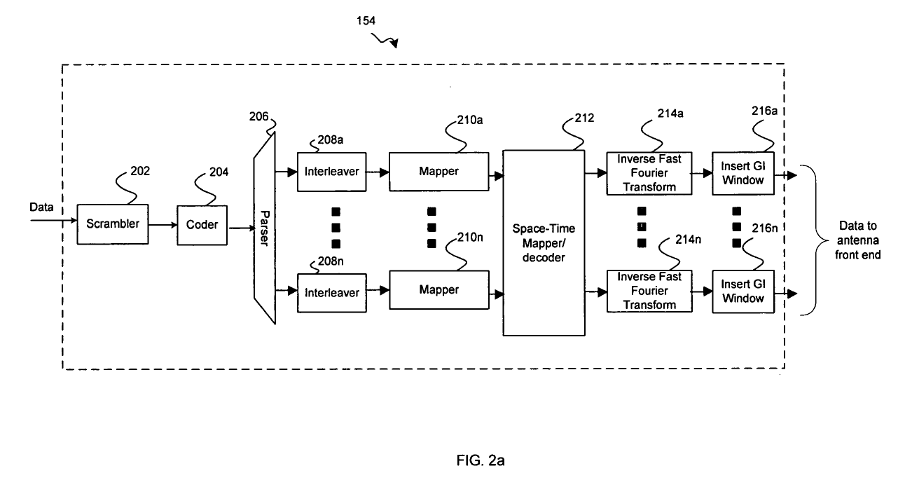

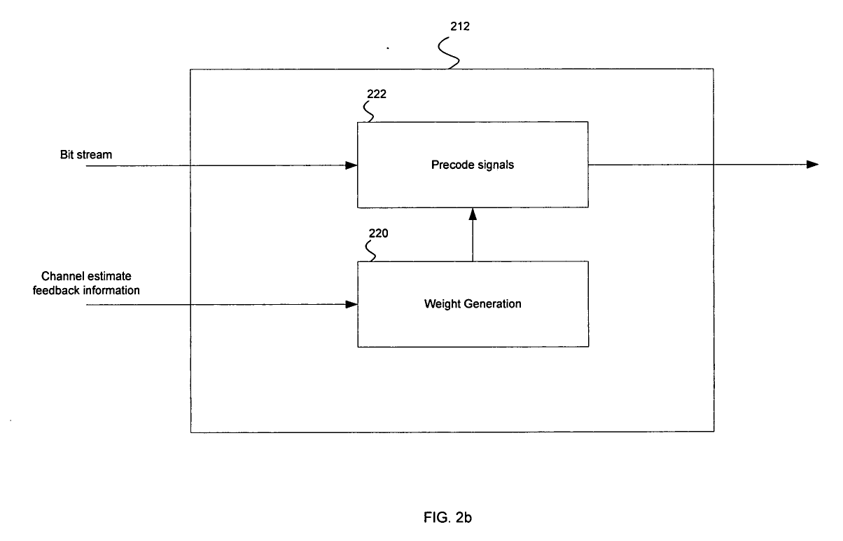

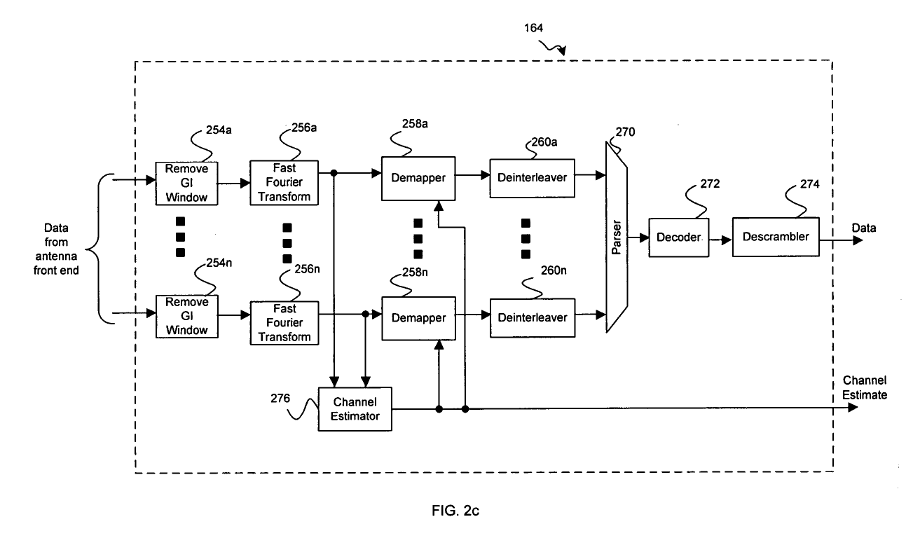

The baseband processor 154 may comprise suitable logic, circuitry, and/or code that may be adapted to process digital data before transmitting the data. The transmit functions for the baseband processor 154 is described in more detail with respect to FIG. 2a. The processor 156 may comprise suitable logic, circuitry, and/or code that may be adapted to control the operations of the antenna front end 152 and/or the baseband processor 154. For example, the processor 156 may be utilized to update and/or modify programmable parameters and/or values in a plurality of components, devices, and/or processing elements in the antenna front end 152 and/or the baseband processor 154. Control and/or data information may be transferred from at least one controller and/or processor external to the transmitter block 150 to the processor 156. Similarly, the processor 156 may transfer control and/or data information to at least one controller and/or processor external to the transmitter block 150.

The processor 156 may utilize the received control and/or data information to determine a mode of operation for the antenna front end 152. For example, the processor 156 may select a specific frequency for a local oscillator, or a specific gain for a variable gain amplifier. Moreover, the specific frequency selected and/or parameters needed to calculate the specific frequency, and/or the specific gain value and/or the parameters needed to calculate the specific gain, may be stored in the system memory 158 via the controller/processor 156. This information stored in system memory 158 may be transferred to the antenna front end 152 from the system memory 158 via the controller/processor 156. The system memory 158 may comprise suitable logic, circuitry, and/or code that may be adapted to store a plurality of control and/or data information, including parameters needed to calculate frequencies and/or gain, and/or the frequency value and/or gain value, and/or converting channel estimates to weights.

Accordingly, the processor 156 may provide data that is to be transmitted to the baseband processor 154. The data may be retrieved from the system memory 158. The baseband processor 154 may process the data, which may include weighting various portions of the data to be transmitted via different antennas, for example, the antennas 150a . . . 150m. The weighting may be based on channel estimates fed back by the mobile terminals 108 . . . 110. The antennas 150a . . . 150m may be similar to the antennas 102a . . . 102m. The weighted data may be communicated to the antenna front end 152. The antenna front end 152 may convert the data to analog signals, filter the analog signals, amplify the analog signals, and/or upconvert the analog signal to an RF signals. The RF signals may be transmitted via the antennas 102a . . . 102m. Accordingly, the weighted signals transmitted by the antennas 102a . . . 102m may be beam formed. The beam formed signals may be received by the mobile terminals 108 . . . 110 with higher signal-to-noise ratio than if the signals were not weighted when transmitted by the antennas 102a . . . 102m.

FIG. 1d is a block diagram of an exemplary receiver block shown in FIG. 1b, in accordance with an embodiment of the invention. Referring to FIG. 1d, the receiver block 160 may comprise a receiver front end 162, a baseband processor 164, a processor 166, and a system memory 168. The receiver front end 162 may comprise suitable logic, circuitry, and/or code that may be adapted to receive an RF signal. The receiver front end 162 may be coupled to at least one external antenna for signal reception and may demodulate a received RF signal before further processing. Moreover, the receiver front end 162 may comprise other functions, for example, filtering the received RF signal, amplifying the received RF signal, and/or downconverting the received RF signal to an analog baseband signal. The receiver front end 162 may also convert the analog baseband signal to a digital baseband signal.

The baseband processor 164 may comprise suitable logic, circuitry, and/or code that may be adapted to process received baseband signals from the receiver front end 162. The receive functions for the baseband processor 164 is described in more detail with respect to FIG. 2c. The processor 166 may comprise suitable logic, circuitry, and/or code that may be adapted to control the operations of the receiver front end 162 and/or the baseband processor 164. For example, the processor 166 may be utilized to update and/or modify programmable parameters and/or values in a plurality of components, devices, and/or processing elements in the receiver front end 162 and/or the baseband processor 164. Control and/or data information may be transferred from at least one controller and/or processor external to the receiver block 160 to the processor 166. Similarly, the processor 166 may transfer control and/or data information to at least one controller and/or processor external to the receiver block 160.

The processor 166 may utilize the received control and/or data information to determine a mode of operation for the receiver front end 162. For example, the processor 156 may select a specific frequency for a local oscillator, or a specific gain for a variable gain amplifier. Moreover, the specific frequency selected and/or parameters needed to calculate the specific frequency, and/or the specific gain value and/or the parameters needed to calculate the specific gain, may be stored in the system memory 168 via the controller/processor 166. This information stored in system memory 168 may be transferred to the receiver front end 162 from the system memory 168 via the controller/processor 166. The system memory 168 may comprise suitable logic, circuitry, and/or code that may be adapted to store a plurality of control and/or data information, including parameters needed to calculate frequencies and/or gain, and/or the frequency value and/or gain value.

Accordingly, the antenna front end 162 may receive RF signals from, for example, at least one of the antennas 160a . . . 160n. At least one of the antennas 160a . . . 160n may receive the beam formed RF signals transmitted by the antennas 102a . . . 102m. The antenna front end 162 may filter the received RF signals, amplify the RF signals, and/or downconvert the RF signals to an analog baseband signal. The receiver front end 162 may also convert the analog baseband signal to a digital baseband signal. The digital baseband signal may be communicated to the baseband processor 164. The baseband processor 164 may process the digital baseband signal to extract information that may have been transmitted. The extracted information may be communicated to the processor 166, which may store the information in the system memory 168.

Additionally, the baseband processor 164 may generate channel estimates from the digital baseband signals. The channel estimates may be fed back to the transmitter, for example the digital television broadcast network 102. In this manner, the transmitter block 150 may receive updated channel estimates to optimize beam forming of the transmitted signals.

FIG. 2a is a block diagram of the exemplary transmitter baseband processor shown in FIG. 1c, in accordance with an embodiment of the invention. Referring to FIG. 2a, there is shown a transmit baseband processor 154. The transmit baseband processor 154 may comprise a scrambler 202, a coder 204, a parser 206, a plurality of interleaver blocks 208a . . . 208n, a plurality of mapper blocks 210a . . . 210n, a space-time mapper block 212, a plurality of inverse fast Fourier transform (IFFT) blocks 214a . . . 214n, a plurality of insert guard interval (GI) window blocks 216a . . . 216n, and a plurality of RF modulation blocks 218a . . . 218n.

The scrambler 202 may comprise suitable circuitry, logic and/or code that may be adapted to scramble a plurality of bits. Scrambling may utilize a scrambling code to introduce randomness into a pattern of bits among the plurality of bits. When transmitted via an RF channel, the received scrambled bits may be characterized by a mean energy level of approximately zero unless descrambled by a corresponding descrambling code. The scrambler 202 may utilize a scrambling algorithm such as Gold codes, for example. The scrambler 202 may be configured to utilize a selected scrambling algorithm.

The coder 204 may comprise suitable circuitry, logic and/or code that may be adapted to generate error detection and/or error correction codes that may be computed based on at least a portion of the bits contained in a frame. The coder 204 may utilize outer codes and/or inner codes. For example, the coder 204 may be adapted to perform Reed-Solomon forward error correction (FEC) code generation. A Reed-Solomon code may be characterized by a tuple (N,K), where N may represent a number of octets containing information from the frame, and K may represent a number of octets containing parity check information. In various embodiments of the invention, the parameter K may be set to a configurable value ranging from K=7 to K=9, for example. For example, the coder 204 may be adapted to perform binary convolutional code (BCC) generation. The coder 204 may be configured to perform BCC based on a coding rate R=½, for example, where R may indicate a number of redundant bits that may be contained within a given plurality of BCC encoded bits. The value R may be set to a configurable value comprising R=⅔, R=¾, or R=⅚, for example.

The parser 206 may comprise suitable circuitry, logic and/or code that may be adapted to assigning bits received in a single bit stream to at least one of a plurality of bit streams. The parser 206 may be configured to assign a bit received from a single bit stream to a selected one or more of the plurality of bit streams.

Each of the plurality of interleaver blocks 208a . . . 208n may comprise suitable circuitry, logic and/or code that may be adapted to rearranging the order in which bits appear in a corresponding bit stream. Each of the plurality of interleaver blocks 208a . . . 208n may be configured to perform a specified rearrangement of the order in which bits appear in a corresponding bit stream.

Each of the plurality of mapper blocks 210a . . . 210n may comprise suitable logic, circuitry, and/or code that may be adapted to map one or more received bits to a symbol based on a specified modulation constellation. For example, a mapper may be adapted to perform X-QAM, where X indicates the size of the constellation to be used for quadrature amplitude modulation (QAM). The selection of a value for X may correspond to a modulation type. Each of the plurality of mapper blocks 210a . . . 210n may be configured to select a modulation type that may be utilized for mapping bits to symbols. Examples of modulation types may comprise binary phase shift keying (BPSK), quaternary phase shift keying (QPSK), 16-QAM, or 64-QAM, for example. The mapping performed by a mapper may produce a modulated signal that comprises an in-phase (I) component and a quadrature phase (Q) component, for example. The signal generated by the mapper may comprise a plurality of symbols. Each of the symbols contained in the signal may be referred to as an OFDM symbol. An OFDM symbol may be associated with a plurality of frequency carriers, where a frequency carrier may represent a signal that is transmitted at a given carrier frequency. Each frequency carrier associated with an OFDM symbol may utilize a different carrier frequency. A portion of the bits encoded into the OFDM symbol by the mapper may be associated with one or more of the frequency carriers.

The space-time mapper block 212 may comprise suitable logic, circuitry, and/or code that may be adapted to generate one or more space-time codes based on bits received from a plurality of bit streams. For example, an individual bit stream from the plurality of bit streams may be multiplicatively scaled, utilizing a plurality of current scale factors, to form a corresponding plurality of current space-time codes. The plurality of current space-time codes may be transmitted at about the current time instant by a transmitter, for example, the transmitter block 150. At a subsequent time instant, at least a portion of the plurality of received bit streams may be multiplicatively scaled, utilizing a plurality of subsequent scale factors, to form a corresponding plurality of subsequent space-time codes. The plurality of subsequent space-time codes may be transmitted at about the subsequent time instant by the transmitter 600.

The space-time mapper block 212 may use information from the channel estimates fed back by the mobile terminals 108 . . . 110. For example, the space-time mapper block 212 may generate weights for the signals transmitted by using the channel estimates in a precoding algorithm. The channel estimate information may be used by, for example, the Tomlinson-Harashima preceding algorithm to weight each bit stream appropriately before the bit stream is transmitted by an antenna. Each weighted bit stream may be transmitted by a different transmit antenna. In this manner, a receiver, for example, the mobile terminal 108, may receive the various transmitted bitstreams such that the signal-to-noise ratio may be increased. Accordingly, the interfering effects of other noise, such as, for example, the analog TV signals may be mitigated.

Each of the plurality of inverse FFT (IFFT) blocks 214a . . . 214n may comprise suitable logic, circuitry, and/or code that may be adapted to perform an IFFT or inverse discrete Fourier transform (IDFT) operation on one or more received symbols. An IFFT operation may be characterized by a number of points where the number of points in the IFFT or IDFT implementation may be equal to the number of points associated with a received OFDM symbol, for example. The number of points utilized by an IFFT block may be set to a configurable value ranging from 64 points to 8,192 points, for example. The signal generated by an IFFT block may be referred to as a spatial stream.

Each of the plurality of insert GI window blocks 216a . . . 216n may comprise suitable logic, circuitry and/or code that may be adapted to insert a guard interval 508 into a corresponding spatial stream. The time duration of the guard interval inserted by an insert GI window block may be set to a configurable value ranging from 400 ns to 800 ns, for example.

In operation, the transmitter block 154 may process data to be transmitted for beam forming transmission using OFDM. For example, the signals transmitted from each of the antennas 102a . . . 102m may be weighted based on channel estimates fed back by the mobile terminals 108 . . . 110. Accordingly, a processor, for example, the processor 156, may configure the scrambler 202 to utilize Gold codes and a specified scrambling code. The processor 156 may configure the coder 204 to utilize Reed-Solomon forward error correction code (FEC) generation with the parity check parameter set to a value K=7, for example. The processor 156 may configure the coder 204 to utilize BCC code generation with the coding rate parameter set to a value R=½, for example.

The processor 156 may configure the parser 206 to utilize a specified pattern for assigning bits from a received single bit stream to a plurality of bit streams. The pattern of assignments of bits from the received single bit stream to each of the plurality of bit streams may be based on the modulation type utilized by at least a portion of the plurality of mapper blocks 210a . . . 210n. The processor 156 may configure each of the plurality of interleavers 208a . . . 208n to rearrange the order of bits in a corresponding one of the received plurality of bit streams. The rearrangement of bits performed by an interleaver may correspond to the modulation type utilized by the corresponding mapper.

The processor 156 may configure at least a portion of the plurality of mapper blocks 210a . . . 210n to utilize the BPSK modulation type, for example. The processor 156 may provide the space-time mapper block 212 with, for example, channel estimates from the mobile terminals 108 . . . 110, or information processed from the channel weights for use in the Tomlinson-Harashima precoding algorithm. The processor 156 may configure at least a portion of the plurality of IFFT blocks 214a . . . 214n to utilize a 64-point IFFT algorithm, for example. The processor 156 may configure the insert guard interval window block 216a . . . 216n to insert an 800 ns guard band, for example. The transmitter block 150 may transmit a frame processed by the baseband processor 154 based on the configured parameters.

The processor 156 may communicate a plurality of bits to be transmitted to the mobile terminals 108 . . . 110 to the scrambler 202. The scrambler 202 may scramble the received plurality of bits to generate scrambled bits utilizing Gold codes, for example. The scrambled bits may be communicated to the coder 204. The coder 204 may apply a Reed-Solomon outer code and a BCC inner code to generate a coded bit stream. The parser 206 may receive the coded bit stream. The parser 206 may assign a first portion of bits from the coded bit stream to a first bit stream, a second portion of bits from the coded bit stream to a second bit stream, and an n^{th} portion of bits from the coded bit stream to an n^{th} bit stream, for example.

The interleaver 208a may receive the first bit stream, and the interleaver 208n may receive the n^{th} bit stream, for example. Each of the plurality of interleavers 208a . . . 208n may rearrange the order of bits from the corresponding received bit stream to generate a corresponding interleaved bit stream. A corresponding interleaved bit stream may be received by a corresponding mapper among the plurality of mappers 210a . . . 210n. The mapper 210a may receive the first interleaved bit stream, for example. Each mapper may organize the bits contained in the corresponding interleaved bit stream into one or more groups of bits where each group of bits may comprise at least a portion of the bits contained in the corresponding interleaved bit stream. Each mapper may map each group of bits to a symbol based on a selected modulation type. The number of bits contained within a group may be determined based on the selected modulation type. For example, when a mapper, such as mapper 210a, utilizes 64-QAM, a group of bits may comprise 6 bits.

The space-time mapper block 212 may process the received bits from the mappers 210a . . . 210n using a precoding algorithm, for example, the Tomlinson-Harashima preceding algorithm. The preceding algorithm may weight the various bit streams in order to increase a signal-to-noise ratio at each receiver, for example, the mobile terminal 108 . . . 110, that feeds back a channel estimate. At least a portion of the IFFT blocks 214a . . . 214n may perform a frequency domain to time domain transformation on corresponding STC symbols generated by the space-time mapper block 212. The transformation may utilize a 64-point IFFT algorithm, for example. At least a portion of the insert GI window blocks 216a . . . 216n may insert guard intervals as shown in 504, 508 and 512a . . . 512b (FIG. 5), for example. At least a portion of the plurality of RF modulation blocks 218a . . . 218n may modulate the corresponding plurality of spatial streams. The plurality of modulated spatial streams may be transmitted via a corresponding plurality of antennas.

FIG. 2b is a block diagram of the exemplary space-time mapper block shown in FIG. 2a, in accordance with an embodiment of the invention. Referring to FIG. 2b, there is shown the space-time mapper block 212 that may comprise a weight generating block 220 and a precoding block 222.

The weight generating block 220 may comprise circuitry, logic, and/or code that may be adapted to receive channel estimate feedback information from the mobile terminals 108 . . . 110 and generate weights for signals. The preceding block 222 may comprise circuitry, logic, and/or code that may be adapted to process received input signals with the weights to generate weighted signals.

In operation, the weight generating block 220 may process the received channel estimate feedback information to generate weights. The channel estimate feedback information may be the channel estimates from the mobile terminals 108 . . . 110, or information that may be been the result of processing the channel estimates by, for example, the processor 156. The weights may be communicated to the precoding block 222. The precoding block 222 may receive bit streams from, for example, the plurality of mapper blocks 210a . . . 210n, and may process the bit streams with the weights from the weight generating block 220. The processed bit streams may be communicated to the IFFT blocks 214a . . . 214n. Accordingly, each of the weighted bit streams may be further processed and subsequently transmitted by a corresponding antenna 102a . . . 102m.

FIG. 2c is a block diagram of an exemplary transmitter baseband processor, in accordance with an embodiment of the invention. Referring to FIG. 2c, there is shown a receive baseband processor 164. The receive baseband processor 164 may comprise a plurality of remove GI window blocks 254a . . . 254n, a plurality of fast Fourier transform (FFT) blocks 256a . . . 256n, a plurality of demapper blocks 258a . . . 258n, a plurality of deinterleaver blocks 260a . . . 260n, a parser 270, a decoder 272, a descrambler 274, and a channel estimator 276.

Each of the plurality of remove GI window blocks 254a . . . 254n may comprise suitable logic, circuitry and/or code that may be adapted to remove a guard interval from a received signal. The time duration of the guard interval removed by a remove GI window block may be set to a configurable value ranging from 400 ns to 800 ns to correspond to the time interval inserted by the corresponding insert GI window block when generating the transmitted signal, for example.

Each of the plurality of FFT blocks 256a . . . 256n may comprise suitable logic, circuitry, and/or code that may be adapted to perform an FFT or discrete Fourier transform (DFT) operation on one or more received symbols. The number of points utilized by an FFT block may be set to a configurable value to correspond to the number of points utilized by the corresponding IFFT block when generating the transmitted signal, for example.

Each of the plurality of demapper blocks 258a . . . 258n may comprise suitable logic, circuitry, and/or code that may be adapted to demap a received symbol into one or more bits based on a specified demodulation constellation. The specified demodulation constellation may be configurable to correspond to the modulation type utilized by the corresponding mapper when generating the transmitted signal, for example. For example, if the corresponding mapper 210a in the transmitter baseband processor 154 utilized a 16-QAM modulation type, the demapper 258a may utilize a demodulation constellation based on the 16-QAM modulation type.

Each of the plurality of deinterleaver blocks 260a . . . 260n may comprise suitable circuitry, logic and/or code that may be adapted to rearranging the order in which bits appear in a corresponding bit stream. Each of the plurality of deinterleaver blocks 260a . . . 260n may be configured to perform a specified rearrangement of the order in which bits appear in a corresponding bit stream that corresponds to a rearrangement performed by the corresponding interleaver block when generating the transmitted signal, for example.

The parser 270 may comprise suitable circuitry, logic and/or code that may be adapted to integrating a plurality of bits from at least one of a plurality of received bit streams into a single bit stream. The parser 270 may be configured to integrate a plurality of bits from one or more bit streams by utilizing a pattern that corresponds to a pattern utilized by the corresponding parser 206 in the transmitter baseband processor 154 when generating the transmitted signal, for example.

The decoder 272 may comprise suitable circuitry, logic and/or code that may be adapted to decode error detection and/or error correction codes in a received bit stream. The decoding of the error detection and/or error correction codes may result in the retrieval of the binary information that was encoded by the corresponding coder 204 in the baseband processor 154 when generating the transmitted signal. The decoder 272 may be configurable to utilize the inner decoding and/or outer decoding algorithm that corresponds to the inner coding and/or outer coding algorithm utilized by the corresponding coder 204 when generating the transmitted signal.

The descrambler 274 may comprise suitable circuitry, logic and/or code that may be adapted to descramble a received plurality of bits. The descrambler 274 may be configurable to utilize a descrambling algorithm and/or descrambling code that corresponds to the scrambling algorithm and/or scrambling code utilized by the corresponding scrambler 202 in the transmitter baseband processor 154 when generating the transmitted signal.

The channel estimator 276 may comprise suitable circuitry, logic and/or code that may be adapted to process the digital signals from the FFT blocks 256a . . . 256n to produce time varying impulse response channel estimates. The combined time varying impulse response channel estimates may be communicated to the plurality of demapper blocks 258a . . . 258n, and to the transmitter, for example, the DVB broadcaster 102.

For example, the channel estimator 276 may use a comb type channel estimation for fast fading channels. This estimation may be used when a channel may change even from one OFDM block to the subsequent OFDM block. The comb-type channel estimation may consist of algorithms to estimate the channel at pilot frequencies and to interpolate the channel inserting pilot tones into each OFDM symbol. The comb-type channel estimation may be based on a Least Square (LS), a Minimum Mean-Square (MMSE), or Least Mean-Square (LMS). The interpolation of the channel for comb-type channel estimation may be dependent on linear interpolation, second order interpolation, low-pass interpolation, spline cubic interpolation, and time domain interpolation.

Another example of channel estimation method may be a block type channel estimation may be performed when the transmitter block 150 inserts pilot tones into subcarriers of OFDM symbols with a specific period. This may be useful for slow fading channels. The estimation of the channel for this block-type pilot arrangement may be based on either a LS or a MMSE. The comb-type channel estimation and block type channel estimation is described in more detail in “A Study of Channel Estimation in OFDM Systems,” by Sinem Coleri, Mustafa Ergen, Anuj Puri, and Ahmad Bahai, IEEE Vehicular Technology Conference, Vancouver, Canada, September 2002, the relevant portions of which are hereby incorporated herein by reference.

In operation, based on information contained in the system memory 168, the processor 166 may configure the descrambler 274 to utilize Gold codes and a specified scrambling code. The processor 166 may configure the decoder 272 to utilize Reed-Solomon decoding with the parity check parameter set to a value K=7, for example. The processor 166 may configure the decoder 272 to utilize BCC code generation with the coding rate parameter set to a value R=½, for example. The processor 166 may configure the parser 270 to utilize a specified pattern for integrating bits from a received plurality of bit streams into a single bit stream. The pattern utilized for integrating bits from the received plurality of bit streams into a bit stream may be based on the BPSK modulation type, for example. The processor 166 may configure each of the plurality of deinterleavers 260a . . . 260n to rearrange the order of bits in a corresponding one of the received plurality of bit streams. The rearrangement of bits performed by an interleaver may correspond to the BPSK modulation type, for example.

The processor 166 may configure at least a portion of the plurality of demapper blocks 258a . . . 258n to utilize the BPSK modulation type, for example. The processor 166 may configure at least a portion of the plurality of FFT blocks 256a . . . 256n to utilize a 64-point FFT algorithm, for example. The processor 166 may configure the remove guard interval window block 254a . . . 254n to insert an 800 ns guard band, for example. The baseband processor 164 may process a received frame based on the configured parameters.

The antenna front end 162 may receive RF signals and convert the RF signals to digital signals. The digital signals may be communicated to the receiver baseband processor 164. At least a portion of the plurality of remove GI window blocks 254a . . . 254n in the receiver baseband processor 164 may remove previously inserted guard intervals. The corresponding plurality of FFT blocks 256a . . . 256n may perform a time domain to frequency domain transformation on the corresponding received signals. The transformed signals may be communicated to the demapper blocks 258a . . . 258n and to the channel estimator 276. At least a portion of the plurality of demapper blocks 258a . . . 258n may demap a corresponding symbol, from one of a plurality of STC symbols, to a plurality of bits. A demapper block may generate a bit stream. At least a portion of the plurality of deinterleaver blocks 260a . . . 260n may rearrange the order of bits in a received bit stream.

The channel estimator 276 may generate channel estimates from the received digital signals. The channel estimates may be communicated to the demapper blocks 260a . . . 260n. The channel estimates may also be fed back to the transmitter, for example, the digital television broadcast network 102. The processing module 102r may process the channel estimates to weight the signals that may be transmitted from the antennas 102a . . . 102m. Although the channel estimates may be described as being communicated to the demapper blocks 260a . . . 260n, the invention need not be so limited. Accordingly, various embodiments of the invention may communicate the channel estimates to the demapper blocks 258a . . . 258n, the deinterleaver blocks 260a . . . 260n, the parser 270, the decoder 272, and/or the descrambler 274.

The parser 270 may integrate bits received from the one or more deinterleaver blocks 260a . . . 260n to generate a single bit stream, for example. The decoder 272 may decode the single bit stream utilizing decoding based on Reed-Solomon FEC and/or BCC, for example. The descrambler 274 may utilize a Gold code algorithm to apply a descrambler code to the decoded and received bits. The descrambled bits may be sent to the processor 404b. A portion of the bits received by the processor 404b may be stored in memory 404d.

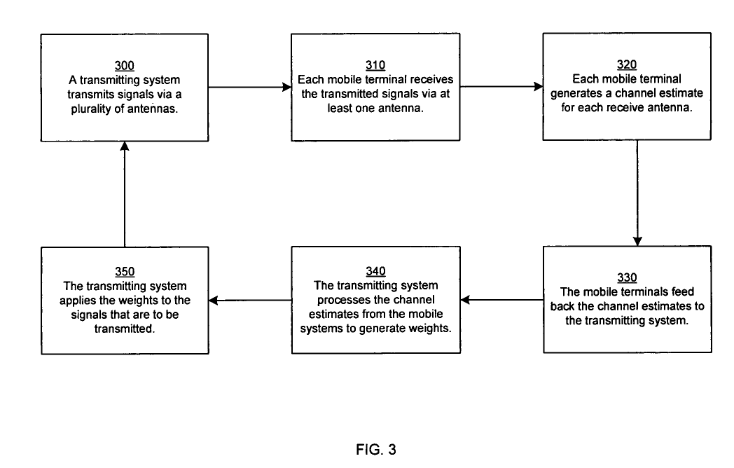

FIG. 3 is a flow diagram illustrating an exemplary routine for reducing noise in received signals, in accordance with an embodiment of the invention. In step 300, a transmitting system may transmit signals via a plurality of antennas. In step 310, mobile terminals may receive the transmitted signals via at least one antenna. In step 320, each mobile terminal may generate a channel estimate for each receive antenna at the mobile terminal. In step 330, each mobile terminal may feed back the channel estimates to the transmitting system. In step 340, the transmitting system may process the received channel estimates to generate weights for the signals to be transmitted. In step 350, the transmitting system may apply the weights to the signals to be transmitted.

Referring to FIG. 3, and with respect to FIGS. 1a, 1b, 1d, and 2b, the steps 300 to 350 may be utilized to transmit signals to reduce noise at the mobile terminals that receive the transmitted signals. In step 300, the transmitting system, for example, the digital television broadcast network 102, may transmit signals via a plurality of antennas 102a . . . 102m. The transmitted signals from each of the antennas 102a . . . 102m may be weighted. Accordingly, transmission of the weighted signals may result in beam forming. The signals received by the mobile terminals 108 . . . 110 may have an increased signal-to-noise ratio when compared to transmitted signals from the same antennas that are not generated using beam forming. Accordingly, the signals received from the transmitting system may be optimized for the mobile terminals 108 . . . 110 such that interference from other transmitting systems, for example, the analog TV broadcast antenna 104, may be mitigated.

In step 310, the mobile terminals 108 . . . 110 may receive the transmitted signals via at least one antenna, for example, the antennas 160a . . . 160n. Each antenna may communicate the received signals to the antenna front end 162, where the signals may be processed and converted to a digital signal. Each stream of the digital signals corresponding to the antennas 160a . . . 160n may be communicated to the baseband processor 164.

In step 320, the channel estimator 276 in the baseband processor 164 may generate channel estimates from the transformed digital data from each of the FFT blocks 256a . . . 256n. The channel estimates may be communicated to a transmit portion of the mobile terminals, for example, the transmitter block 150. In step 330, the transmitter block 150 may transmit the channel estimates as feedback signals to the digital television broadcast network 102.

In step 340, the space-time mapper block 212 may use the channel estimates, or information from the channel estimates, to generate a weight each of the signals being transmitted. The information from the channel estimate may be used by, for example, the Tomlinson-Harashima precoding algorithm to weight each bit stream appropriately. In step 350, the transmitting system may apply the weights to the signals to be transmitted. In this manner, a receiver, for example, in the mobile terminal 108, may receive the various transmitted bitstreams such that the signal-to-noise ratio may be increased. Accordingly, the interfering effects of other noise, such as, for example, the analog TV signals may be mitigated.

In accordance with an embodiment of the invention, aspects of the system may comprise the antennas 102a . . . 102m and/or 102n that may receive feedback information from at least one mobile terminal 108 . . . 110. The mobile terminal 108 . . . 110 may receive digital broadcast television signals from the antennas 102a . . . 102m and interfering analog broadcast television signals from the antenna 104. A baseband processor 154 may adjust subsequently transmitted digital broadcast television signals using a plurality of weights based on the received feedback information to mitigate the interfering analog broadcast television signal. The feedback information may comprise channel estimates.

The processing module 102r receives the feedback information via an uplink cellular channel or other out-of-band channels. The processing module 102r may also receive the feedback information via an uplink channel in a digital broadcast television system. The antennas 102a . . . 102m and/or the dedicated receive antenna 102n may receive the feedback information from the mobile terminals 108 . . . 110.

The baseband processor 154 may generate the plurality of weights based on the feedback information. The plurality of weights may be used to beam form the signals transmitted from the antennas 102a . . . 102m. Beam forming may mitigate the interfering analog broadcast television signals. The plurality of weights generated by the baseband processor 154 used for the signals that are transmitted from the antennas 102a . . . 102m may control a direction of propagation of the transmitted digital broadcast television signals, and may be based on the feedback information.

A space-time mapper 212 may provide precoding to the subsequently transmitted digital broadcast television signals based on the feedback information to mitigate the interfering analog broadcast television signals. The space-time mapper 212 may utilize Tomlinson-Harashima preceding algorithm.

Accordingly, the present invention may be realized in hardware, software, or a combination of hardware and software. The present invention may be realized in a centralized fashion in at least one computer system, or in a distributed fashion where different elements are spread across several interconnected computer systems. Any kind of computer system or other apparatus adapted for carrying out the methods described herein is suited. A typical combination of hardware and software may be a general-purpose computer system with a computer program that, when being loaded and executed, controls the computer system such that it carries out the methods described herein.

The present invention may also be embedded in a computer program product, which comprises all the features enabling the implementation of the methods described herein, and, which, when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method for processing signals in a wireless communication system, the method comprising:
receiving from at least one mobile terminal that receives digital broadcast television signals and interfering analog broadcast television signals, feedback information comprising channel estimates; and
adjusting subsequently transmitted digital broadcast television signals using a plurality of weights based on said received feedback information to mitigate said interfering analog broadcast television signal.

2. The method according to claim 1, further comprising receiving said feedback information via an uplink cellular channel.

3. The method according to claim 1, further comprising receiving said feedback information via an uplink channel in a digital television system.

4. The method according to claim 1, further comprising receiving said feedback information via a dedicated uplink channel accessible by said at least one mobile terminal.

5. The method according to claim 1, further comprising generating within a digital broadcast television system, said plurality of weights.

6. The method according to claim 1, utilizing beam forming to mitigate said interfering analog broadcast television signal based on said feedback information.

7. The method according to claim 1, further comprising controlling a direction of propagation of said subsequently transmitted digital broadcast television signals based on said feedback information.

8. The method according to claim 1, further comprising precoding said subsequently transmitted digital broadcast television signals based on said feedback information to mitigate said interfering analog broadcast television signals.

9. The method according to claim 8, wherein said precoding comprises Tomlinson-Harashima preceding algorithm.

10. The method according to claim 1, further comprising receiving said feedback information via an out-of-band channel.

11. A system for processing signals in a wireless communication system, the system comprising:
circuitry that receives from at least one mobile terminal that receives digital broadcast television signals and interfering analog broadcast television signals, feedback information comprising channel estimates; and
a baseband processor that adjusts subsequently transmitted digital broadcast television signals using a plurality of weights based on said received feedback information to mitigate said interfering analog broadcast television signal.

12. The system according to claim 11, wherein said circuitry receives said feedback information via an uplink cellular channel.

13. The system according to claim 11, wherein said circuitry receives said feedback information via an uplink channel in a digital broadcast television system.

14. The system according to claim 11, wherein said circuitry receives said feedback information via a dedicated uplink channel accessible by said at least one mobile terminal.

15. The system according to claim 11, wherein said baseband processor generates said plurality of weights.

16. The system according to claim 11, wherein said baseband processor utilizes beam forming to mitigate said interfering analog broadcast television signal based on said feedback information.

17. The system according to claim 11, wherein said baseband processor controls a direction of propagation of said subsequently transmitted digital broadcast television signals based on said feedback information.

18. The system according to claim 11, further comprising a space-time mapper that precodes said subsequently transmitted digital broadcast television signals based on said feedback information to mitigate said interfering analog broadcast television signals.

19. The system according to claim 18, wherein said space-time mapper precoding utilizes Tomlinson-Harashima precoding algorithm.

20. The system according to claim 11, wherein said circuitry receives said feedback information via an out-of-band channel.
